(19) United States
(12) Patent Application Publication
(10) Pub. No.: US 2023/0322998 A1
(43) Pub. Date: Oct. 12, 2023

(54) PHOTO-CURABLE RESIN COMPOSITION FOR USE IN STEREOLITHOGRAPHY

(71) Applicant: BLUE CUBE IP LLC, St. Louis, MO (US)

(72) Inventors: Huifeng Qian, Pearland, TX (US); Wells Carter, Pearland, TX (US)

(21) Appl. No.: 18/000,626

(22) PCT Filed: May 28, 2021
(86) PCT No.: PCT/US2021/034867

§ 371 Date: Dec. 2, 2022

Related U.S. Application Data
(60) Provisional application No. 63/033,359, filed on Jun. 2, 2020.

(51) Int. Cl. C08F 283/10; B33Y 70/00

(52) U.S. Cl. CPC C08F 283/10; B33Y 70/00; B29C 64/124

(57) ABSTRACT

Provided herein is a curable liquid stereolithography resin comprising (a) a divinylarene dioxide, such as for example a divinylbenene dioxide (DVBDO); (b) a free radically curable component, such as for example a (meth)acrylate component; (c) a cationic photoinitiator; and (d) a free radical photoinitiator. The stereolithography resin may comprise additional components, such as a cationically curable component other than a divinylarene dioxide. Preferably, the stereolithography resin has a viscosity at 25° C. of less than 400 mPa·s.

### CROSS-REFERENCE

This application claims the benefit of priority from U.S. Provisional Patent Application 63/033,359 filed on Jun. 2, 2020, the disclosure of which is incorporated herein by reference.

### BACKGROUND

Stereolithography is a form of 3D printing technology that converts liquid starting materials into solid parts, layer by layer, by selectively curing them using a light source in a process called photo-polymerization. Stereolithography is widely used to create prototypes, patterns, and production parts from engineering and product design to manufacturing, dentistry, jewelry, and education applications. See, for example, U.S. Pat. No. 4,575,330 to Charles W. Hull, entitled “Apparatus for production of three-dimensional objects by stereolithography,” the entire contents of which are incorporated herein by reference.

Photo-curable resins currently used in stereolithography generally contain a cationically polymerizable component, such as an epoxy, and/or a radically polymerizable compound, such as acrylate, together with one or more cationic and/or radical photoinitiators.

Stereolithography resins based on epoxy chemistry provide significantly improved part accuracy, dimensional stability and mechanical properties relative to stereolithography resins based solely upon acrylate chemistry. However, to be useful in stereolithography applications, an epoxy resin must exhibit low viscosity, a high degree of photo-curability, low shrinkage, and must provide good mechanical properties of cured parts produced from the resin. Cycloaliphatic epoxy resins (e.g., ERL-4221, available from Polysciences, Inc.) and hydrogenated bisphenol A epoxy resins (e.g., Epalloy 5000, available from CVC Thermoset Specialties) are commonly used in stereolithography applications. Unfortunately, both classes of epoxy resins suffer from significant drawbacks. Cured parts based on cycloaliphatic epoxy resins are brittle, and the UV cure response of cycloaliphatic epoxy resins is moderate at best. Likewise, hydrogenated bisphenol A epoxy resins suffer from a high viscosity (about 5,000 mPa·s at room temperature), which makes them difficult to work with in stereolithography applications.

Accordingly, it is desirable to develop epoxy resins with low viscosity, fast photo-curability, and providing good mechanical properties of the cured polymer that are suitable for use in stereolithography applications. In particular, it is desirable to develop epoxy resins that are suitable for creating rigid, mechanically strong, three-dimensional objects using stereolithography.

### SUMMARY

Provided herein is a curable liquid stereolithography resin comprising (a) a divinylarene dioxide; (b) a free radically curable component; (c) a cationic photoinitiator; and (d) a free radical photoinitiator.

In some embodiments, the curable liquid stereolithography resin may further comprise a cationically curable component other than divinylarene dioxide. Preferably, the said curable liquid stereolithography resin is photocurable to form a cured resin having a measureable Shore D hardness of least about 75, at least about 80, or at least about 85.

Also provided herein is a method of creating an object using stereolithography, the method comprising the steps of: (a) selectively applying a curable liquid stereolithography resin to a surface; (b) selectively applying electromagnetic radiation to the curable liquid stereolithography resin to form a first cured resin layer; (c) applying a second layer of the curable liquid stereolithography resin on the first cured resin layer; and (d) selectively applying electromagnetic radiation to the second layer of the curable liquid stereolithography resin to form a second cured resin layer, wherein the curable liquid stereolithography resin is as described herein.

Also provided herein is a cured object produced using a stereolithography resin as described herein. For example, the cured object may be produced using a stereolithography process.

Other objects and features will be in part apparent and in part pointed out hereinafter.

### DETAILED DESCRIPTION

Provided herein is a curable liquid stereolithography resin comprising (a) a divinylarene dioxide; (c) a free radically curable component; (d) a cationic photoinitiator; (e) a free radical photoinitiator. The curable liquid stereolithography resin may further comprise one or more optional additives. For example, the curable liquid stereolithography resin may further comprise a cationically curable component other than divinylarene dioxide. Each of these components is discussed in further detail below.

The curable liquid stereolithography resin provides several beneficial advantages that are discussed in further detail below. In preferred embodiments, the stereolithography resin has a viscosity at 25° C. of less than 400 mPa·s. For example, the stereolithography resin may have a viscosity at 25° C. of less than 350 mPa·s, less than 300 mPa·s, less than 250 mPa·s, or even less than 200 mPa·s.

Preferably, the Tg of photo-cured and post-UV-processed parts prepared using the stereolithography resin is above 40 ° C. For example, the Tg of photo-cured and ost-UV-processed parts prepared using the stereolithography resin may be above 75° C., above 80° C., above 85° C., above 90° C., or even above 95° C.

### (a) Divinylarene Dioxide

The stereolithography resin may comprise one or more divinylarene dioxide compounds. As used herein, the term “divinylarene dioxide” refers to a compound comprising two epoxide groups attached directly to one aromatic ring. As a non-limiting example, the stereolithography resin may comprise a divinylbenzene dioxide (“DVBDO”).

In comparison to typical epoxy resins (such as resins derived from bisphenol A) or conventional reactive diluents (such as 1,4-butanediol diglycidyl ether (BDDGE)), divinylarene dioxide resins exhibit several attractive physical and chemical properties. For example, divinylarene dioxides typically exhibit a low viscosity (for example, less than about 50 mPa·s, less than about 40 mPa·s, less than about 30 mPa·s, or even less than about 20 mPa·s at 25° C.), and cured materials prepared from divinylarene dioxide resins exhibit a high glass transition temperature (Tg). Unlike many conventional resins, divinylarene dioxides will cure rapidly in the presence of ultraviolet light. Additionally, preferred divinylarene dioxides are halogen-free, and particularly free of chlorine.

The use of a divinylarene dioxide such as DVBDO in a curable liquid stereolithography resin is found to provide the above-mentioned benefits of high speed UV processing, lower viscosity versus conventional epoxide materials, and high glass transition temperature of the cured products. In addition, it has been unexpectedly found that the hydrolytic stability of a divinylarene dioxide such as DVBDO versus other known dioxides such as 1,3-diisopropenylbenzene dioxide (DIPBDO) is significantly improved. See, for example, U.S. Pat. No. 9,695,272 B2, the entire contents of which are incorporated herein by reference. As is known by the skilled artisan, special and expensive measures are required for the formulating, handling, shipping, and processing of hydrolytically unstable compounds.

The divinylarene dioxides useful in the compositions and methods provided herein, particularly those derived from divinylbenzene such as for example DVBDO, are class of diepoxides which have a relatively low liquid viscosity but impart higher heat resistance and rigidity in its derived cured compositions than do conventional epoxy resins. The epoxide group in divinylarene dioxides is significantly less reactive than that in conventional glycidyl ethers used to prepare prior art hydrolyzed epoxy resins.

The divinylarene dioxide useful in the compositions and methods provided herein may comprise, for example, any substituted or unsubstituted arene nucleus bearing two vinyl groups in any ring position. The arene portion of the divinylarene dioxide may consist of benzene, substituted benzenes, (substituted) ring-annulated benzenes or homologously bonded (substituted) benzenes, or mixtures thereof. The divinylbenzene portion of the divinylarene dioxide may be ortho, meta, or para isomers or any mixture thereof. Additional substituents may consist of H₂O₂-resistant groups including saturated alkyl, aryl, halogen, nitro, isocyanate, or RO— (where R may be a saturated alkyl or aryl). Ring-annulated benzenes may consist of naphthalene, tetrahydronaphthalene, and the like. Homologously bonded (substituted) benzenes may consist of biphenyl, diphenylether, and the like.

The divinylarene dioxide such as DVBDO used in the curable liquid stereolithography resins provided herein may be prepared, for example, by reacting a divinylarene and hydrogen peroxide. In one embodiment, the divinylarene dioxide may be produced, for example, by the process described in U.S. Patent Application Ser. No. 61/141,457, filed Dec. 30, 2008, by Marks et al., incorporated herein by reference.

The divinylarene dioxide used in the compositions and methods provided herein may be illustrated generally by general chemical Structures II-V as follows:

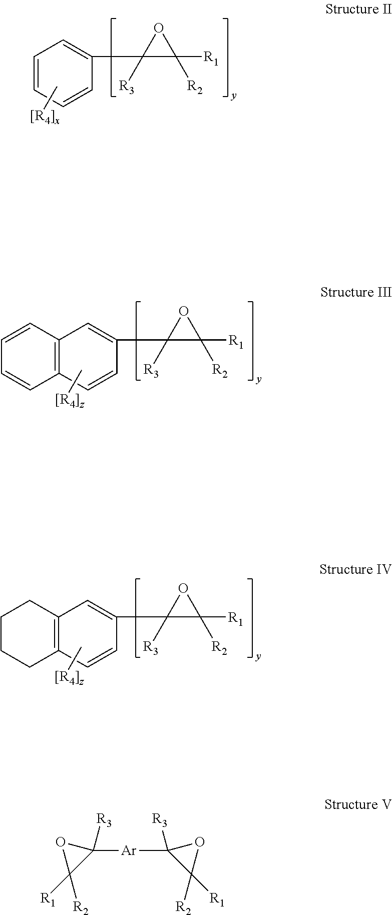

In the above Structures II, III, IV and V of the divinylarene dioxide comonomer, each R₁, R₂, and R₄ individually may be hydrogen, an alkyl, cycloalkyl, an aryl or an aralkyl group; or a H₂O₂-resistant group including for example a halogen, a nitro, or an RO group, wherein R may be an alkyl, aryl or aralkyl; R₃ is hydrogen; x may be an integer of 0 to 4; y may be an integer greater than or equal to 2; x+y may be an integer less than or equal to 6; z may be an integer of 0 to 6; and z+y may be an integer less than or equal to 8; and Ar is an arene fragment including for example, 1,3-phenylene group.

Non-limiting examples of suitable divinylarene dioxides include divinylbenzene dioxide, divinylnaphthalene dioxide, divinylbiphenyl dioxide, divinyldiphenylether dioxide, and mixtures thereof.

Structure VI below illustrates an embodiment of a preferred chemical structure of a DVBDO useful in the curable liquid stereolithography resins provided herein.

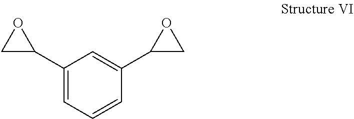 [SMILES: c1cc(C2CO2)cc(C2CO2)c1]

Structure VII below illustrates another embodiment of a preferred chemical structure of a DVBDO useful in the curable liquid stereolithography resins provided herein.

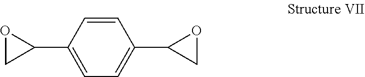 [SMILES: c1cc(C2CO2)ccc1C1CO1]

When DVBDO is prepared by the processes known in the art, it is possible to obtain one of three possible isomers: ortho, meta, and para. Accordingly, the curable liquid stereolithography resins provided herein may include a DVBDO illustrated by any one of the above Structures individually or as a mixture thereof. Structures VI and VII above show the meta (1,3-DVBDO) and para isomers of DVBDO, respectively. The ortho isomer is rare; and usually DVBDO is mostly produced as an about 2:1 ratio of meta (Structure VI) to para (Structure VII). For example, in one embodiment, the curable liquid stereolithography resins provided herein include DVBDO in a ratio of Structure VI to Structure VII of about 2:1 (for example, from 1:1 to 3:1).

In another embodiment, the divinylarene dioxide may contain quantities (such as for example less than about 20 weight percent) of substituted arenes. The amount and structure of the substituted arenes depend on the process used in the preparation of the divinylarene precursor to the divinylarene dioxide. For example, divinylbenzene prepared by the dehydrogenation of diethylbenzene (DEB) may contain quantities of ethylvinylbenzene (EVB) and DEB. Upon reaction with hydrogen peroxide, EVB produces ethylvinylbenzene monoxide while DEB remains unchanged. The presence of these compounds can increase the epoxide equivalent weight of the divinylarene dioxide to a value greater than that of the pure compound.

In one embodiment, the divinylarene dioxide, for example DVBDO, useful in the curable liquid stereolithography resins provided herein comprises a low viscosity liquid epoxy resin (LER) composition. The viscosity of the divinylarene dioxide used in the process for making the epoxy resin composition ranges generally from about 2 mPa·s to about 100 mPa·s, preferably from about 2 mPa·s to about 50 mPa·s, and more preferably from about 4 mPa·s to about 25 mPa·s at 25° C.

One of the advantageous properties of the divinylarene dioxides useful in the curable liquid stereolithography resins provided herein is their thermal stability, which allows their use in formulations or processing at moderate temperatures (for example, at from about 100° C. to about 200° C.) for up to several hours (for example, for at least 2 hours) without oligomerization or homopolymerization. Oligomerization or homopolymerization during formulation or processing is evident by a substantial increase in viscosity or gelling (crosslinking). The divinylarene dioxides useful in the curable liquid stereolithography resins provided herein have sufficient thermal stability such that the divinylarene dioxides do not experience a substantial increase in viscosity or gelling during formulation or processing at moderate temperatures.

Another advantageous property of the divinylarene dioxide useful in the curable liquid stereolithography resin may be, for example, its rigidity. The rigidity property of the divinylarene dioxide is measured by a calculated number of rotational degrees of freedom of the dioxide excluding side chains using the method of Bicerano described in Prediction of Polymer Properties, Dekker, New York, 1993. The rigidity of the divinylarene dioxide used in the curable liquid stereolithography resin may range generally from about 6 to about 10, preferably from about 6 to about 9, and more preferably from about 6 to about 8 rotational degrees of freedom.

Non-limiting examples of the divinylarene dioxide include meta- and para-DVBDO and mixtures thereof; meta- and para-ethylvinylbenzene oxide (EVBO) and mixtures thereof; and optional ingredients that include meta- and para-divinylbenzene monoxide (DVBMO) and mixtures thereof; and additional optional ingredients that include oligomers.

The DVBDO used can be a crude DVBDO, i.e. a DVBDO wherein DVBDO is less than 100% purity when manufactured. For example, a DVBDO that can be used herein includes a DVBDO product containing at least 55% DVBDO and greater, preferably 80% and more preferably 95%.

A preferred embodiment of the divinylarene dioxide used to prepare the curable liquid stereolithography resin can be characterized by having a viscosity of from about 2 mPa·s to about 100 mPa·s, preferably from about 3 mPa·s to about 50 mPa·s, more preferably from about 4 mPa·s to about 25 mPa·s, and most preferably from about 4 mPa·s to about 15 mPa·s at 25° C.

A particularly preferred divinylarene dioxide is XU19127.00 Experimental Epoxy Resin from Olin Corporation.

### Amount of the Divinylarene Dioxide

Generally, the stereolithography resin may comprise the divinylarene dioxide in an amount of from about 2% by weight to about 80% by weight of the composition, for example, in an amount of from about 2% by weight to about 70% by weight, from about 2% by weight to about 60% by weight, or from about 2% by weight to about 50% by weight of the composition.

Surprisingly, it has been discovered that the benefits provided by the divinylarene dioxide component may be achieved even when this component is present in the stereolithography resin in a relatively low concentration. For example, as discussed in further detail below, the stereolithography resin may optionally comprise a cationically curable component other than divinylarene dioxide. This allows the concentration of the divinylarene dioxide component to be reduced while still achieving the advantages described herein.

For example, in some embodiments, the stereolithography resin may comprise the one or more divinylarene dioxide compounds in an amount of less than about 40% by weight, less than about 30% by weight, or less than about 20% by weight of the composition. For example, the stereolithography resin may comprise the one or more divinylarene dioxide compounds in an amount of from about 2% by weight to about 40% by weight, from about 3% by weight to about 30% by weight, from about 5% by weight to about 25% by weight, from about 5% by weight to about 20% by weight, or from about 10% by weight to about 15% by weight of the composition.

### (c) Free Radically Curable Component

The stereolithography resin may further comprise a free radically curable component. The free radically curable component comprises at least one ethylenically unsaturated compound, which is curable by polymerization in the presence of a free radical catalyst. For example, the free radically curable component could comprise one or more (meth)acrylate, vinyl ether, allyl ether, allyl ester, aromatic vinyl compound, unsaturated ester, or vinyl ester compounds, or the like.

In preferred embodiments, the free radically curable component comprises one or more (meth)acrylate compounds. As used herein, “(meth)acrylate compounds” are compounds having one or more ethylenically unsaturated groups, for example compounds having one or more acrylate or methacrylate groups.

Suitable monofunctional ethylenically unsaturated compounds include isobornyloxyethyl (meth)acrylate, isobornyl (meth)acrylate, 2-ethylhexyl (meth)acrylate, ethyldiethylene glycol (meth)acrylate, lauryl (meth)acrylate, dicyclopentadiene (meth)acrylate, dicyclopentenyloxyethyl (meth)acrylate, dicyclopentenyl (meth)acrylate, 2-tetrachlorophenoxyethyl (meth)acrylate, tetrahydrofurfuryl (meth)acrylate, tetrabromophenyl (meth)acrylate, 2-tetrabromophenoxyethyl (meth)acrylate, 2-trichlorophenoxyethyl (meth)acrylate, tribromophenyl (meth)acrylate, 2-tribromophenoxyethyl (meth)acrylate, 2-hydroxyethyl (meth)acrylate, 2-hydroxypropyl (meth)acrylate, phenoxyethyl (meth)acrylate, butoxyethyl (meth)acrylate, pentachlorophenyl (meth)acrylate, pentabromophenyl (meth)acrylate, polyethylene glycol mono(meth)acrylate, polypropylene glycol mono(meth)acrylate, bornyl (meth)acrylate, methyltriethylene diglycol (meth)acrylate, and the like.

Suitable polyfunctional radically polymerizable compounds include ethylene glycol di(meth)acrylate, dicyclopentenyl di(meth)acrylate, Dicyclopentadienedimethanoldiacrylate, triethylene glycol diacrylate, tetraethylene glycol di(meth)acrylate, tricyclodecanediyldimethylene di(meth)acrylate, trimethylolpropane tri(meth)acrylate, ethylene oxide (hereinafter may be abbreviated as “EO”) modified trimethylolpropane tri(meth)acrylate, propylene oxide (hereinafter may be abbreviated as “PO”) modified trimethylolpropane tri(meth)acrylate, tripropylene glycol di(meth)acrylate, neopentyl glycol di(meth)acrylate, single terminal or both-terminal (meth)acrylic acid adduct of bisphenol A diglycidyl ether, 1,4-butanediol di(meth)acrylate, 1,6-hexanediol di(meth)acrylate, pentaerythritol tri(meth)acrylate, pentaerythritol tetra(meth)acrylate, polyethylene glycol di(meth)acrylate, dipentaerythritol hexa(meth)acrylate, dipentaerythritol penta(meth)acrylate, dipentaerythritol tetra(meth)acrylate, ditrimethylolpropane tetra(meth)acrylate, EO-modified bisphenol A di(meth)acrylate, PO-modified bisphenol A di(meth)acrylate, EO-modified hydrogenated bisphenol A di(meth)acrylate, PO-modified hydrogenated bisphenol A di(meth)acrylate, EO-modified bisphenol F di(meth)acrylate, (meth)acrylate of phenol novolac polyglycidyl ether, and the like.

Additional non-limiting examples of acrylated materials include tripropylene glycol diacrylate, trimethylolpropane triacrylate, neopentylglycol diacrylate, pentaerythritol tetra-acrylate, dipentaerythritol hexa-acrylate, ethoxylated acrylates, propoxylated acrylates, mixed ethoxylated and propoxylated acrylates, epoxy acrylates, urethane acrylates, polyester acrylates, and a host of acrylate compounds including monomers, oligomers, and polymers available from Sartomer, from Cytec for example under the trade names Ebecryl and Ucecoat, from Toagosei for example under the trade name Aronix, and acrylates available from others.

The stereolithography resin may comprise the free radically curable (meth)acrylate component, for example, in an amount of from about 10% by weight to about 60% by weight, from about 10% by weight to about 40% by weight, from about 15% by weight to about 35% by weight, or from about 20% by weight to about 30% by weight of the composition.

For example, in some embodiments, the curable liquid stereolithography resin comprises the free radically curable (meth)acrylate component in an amount of at most about 40% by weight, at most about 35% by weight, at most about 30% by weight, or at most about 25% by weight.

### (d) Cationic Photoinitiator

The stereolithography resin may further comprise a cationic photoinitiator. Generally, the cationic photoinitiator useful in preparing the stereolithography resin may comprise any conventional photoinitiator compound or a combination of two or more such compounds.

For example, the cationic photoinitiator may comprise Irgacure 290, Cyracure UVI6992, Curacure UVI6976, or a mixture thereof. Other suitable cationic photoinitiators are described, for example, in U.S. Pat. Nos. 4,105,806; 4,197,174; 4,201,640; 4,247,472; 4,247,473; 4,161,478; 4,058,400; 4,058,401; 4,138,255; 4,175,972; 4,273,668; 4,173,476; 4,186,108; 4,218,531; and 4,231,951; each of which is incorporated herein by reference.

Other examples of cationic photoinitiators that are useful in the present invention include [4-(octyloxy)phenyl]phenyliodonium hexafluorophospate also known as FP5384; (4-methoxyphenyl)phenyliodonium trifluormethanesulfonate, i.e., triflate also known as FP5311; bis(4-tertiary-butylphenyl)iodonium hexafluoroantimonate also known as FP5034; cyclohexyltosylate also known as FP5102; (4-methyl-4-(trichloromethyl)-2,5-cyclohexadienone also known as FP5510 available from Hampford Research Inc. Stratford, Conn. and related compounds; and mixtures thereof; and diphenyliodonium PF₆ available from Sigma-Aldrich, Milwaukee, Wis. and related compounds and mixtures thereof.

Other examples of cationic photoinitiators include (4-methylphenyl)(4′-isobutylphenyl)iodonium hexafluorophospate also known as Irgacure 250 available from BASF and related compounds; high molecular weight sulfonium tetrakis[pentafluorophenyl] boratediarylferrocinium salt, also known as Irgacure 290 from BASF; high-molecular-weight sulfonium hexafluro phosphate, also known as Omnicat 270 from IGM Resins; triarylsulfonium hexafluorophosphate salts, also known as UVI-6992 or CPI-6992 from Advanced Research Chemicals, Inc.; triphenyl-sulfonium SbF₆ also known as Chivacure 548 available from Chitec Technology Company Limited, Taipei City, Taiwan, Republic of China (Chitec) and related compounds; and mixtures thereof.

Some preferred examples of the cationic photoinitiator may include, for example, compounds that contain diphenyl-(phenylthiophenyl)sulfonium cation; bis[4-(diphenylsulfonio)phenyl]sulfide bis cation; triphenylsulfonium cation; [4-(octyloxy)phenyl]phenyliodonium cation; (4-methoxy-phenyl)phenyliodonium cation; bis(4-tertiary-butylphenyl)iodonium cation; (4-methylphenyl)(4′-isobutylphenyl)iodonium cation; and mixtures thereof.

Some of the most preferred cationic photoinitiators useful in the compositions provided herein comprise, for example, diphenyl(phenylthiophenyl)sulfonium; bis[4-(diphenylsulfonio)phenyl]sulfide; the cationic photoinitiators disclosed in U.S. Pat. Nos. 7,671,081; 7,598,401; 7,335,782; 7,294,723; and 7,101,998, each of which is fully incorporated herein by reference; and mixtures thereof.

The stereolithography resin may comprise the cationic photoinitiator, for example, in an amount of from about 0.05% by weight to about 10% by weight, from about 0.1% by weight to about 5% by weight, from about 0.1% by weight to about 4% by weight, 15 from about 0.1% by weight to about 3% by weight, from about 0.1% by weight to about 2% by weight or from about 0.1% by weight to about 1% by weight of the composition.

### (e) Free Radical Photoinitiator

The stereolithography resin may further comprise a free radical photoinitiator. The free radical photoinitiator decomposes by exposure to energy rays, such as light, to initiate the radical polymerization of the component. The energy ray such as light used herein refers to visible light, ultraviolet light, infrared light, X-rays, α-rays, β-rays, γ-rays, and the like.

Non-limiting examples of the radical photopolymerization initiators useful in the compositions provided herein include acetophenone, acetophenone benzyl ketal, anthraquinone, 1-(4-isopropylphenyl)-2-hydroxy-2-methylpropan-1-one, carbazole, xanthone, 4-chlorobenzophenone, 4,4′-diaminobenzophenone, 1,1-dimethoxydeoxybenzoin, 3,3′-dimethyl-4-methoxybenzophenone, thioxanethene compounds, 2-methyl-1-[4-(methylthio)phenyl]-2-morpholino-propan-2-one, 2-benzyl-2-dimethylamino-1-(4-morpholinophenyl)-butan-1-one, triphenylamine, 2,4,6-trimethylbenzoyldiphenylphosphine oxide, bis(2,6-dimethoxybenzoyl)-2,4,4-trimethylpentylphosphine oxide, benzyl methyl ketal, 1-hydroxycyclohexyl phenyl ketone, 2-hydroxy-2-methyl-1-phenylpropan-1-one, fluorenone, fluorene, benzaldehyde, benzoin ethyl ether, benzoin propyl ether, benzophenone, Michler's ketone, 3-methylacetophenone, 3,3′,4,4′-tetra(t-butylperoxycarbonyl)benzophenone (BTTB), combinations of BTTB and dye sensitizers such as xanthene, thioxanthene, cumarin, and ketocumarin, and the like. Of these, benzyl dimethyl ketal, 1-hydroxycyclohexyl phenyl ketone, 2,4,6-trimethylbenzoyldiphenylphosphine oxide, 2-benzyl-2-dimethylamino-1-(4-morpholinophenyl)-butan-1-one, and the like are particularly preferable.

The curable liquid stereolithography resin may comprise the free radical photoinitiator, for example, in an amount of from about 0.1% by weight to about 10% by weight, from about 0.2% by weight to about 9% by weight, from about 0.3% by weight to about 8% by weight, from about 0.4% by weight to about 7% by weight, from about 0.5% by weight to about 6% by weight, or from about 0.5% by weight to about 5% by weight of the composition.

### Cationically Curable Component

Optionally, the stereolithography resin may further comprise a cationically curable component other than divinylarene dioxide.

The cationically curable component includes at least one cationically curable compound characterized by having functional groups capable of reacting via or as a result of a ring-opening mechanism initiated by cations to form a polymeric network. Examples of such functional groups include epoxy, oxetane, tetrahydrofuran, and lactone groups. Such compounds may have an aliphatic, aromatic, cycloaliphatic, araliphatic or heterocyclic structure and they may contain the ring groups as side groups, or the functional group can form part of an alicyclic or heterocyclic ring system. The cationically curable compound may be difunctional, trifunctional or may contain more than three cationically curable groups.

As a non-limiting example, U.S. Pat. No. 7,309,122 discloses epoxy compounds, vinyl ether compounds, and oxetane compounds that are photocationically polymerizable and are useful cationically reactive components of the curable liquid stereolithography resins provided herein.

### Epoxides

For example, the cationically curable component may comprise one or more epoxides. As used herein, the term “epoxide” refers to a compound comprising at least one epoxy functional group. Examples of suitable epoxides are described by Pham, H. Q. and Marks, M. J., Epoxy Resins in the Kirk-Othmer Encyclopedia of Chemical Technology; John Wiley & Sons, Inc.: online Dec. 4, 2004 and in the references therein; Lee, H. and Neville, K., Handbook of Epoxy Resins, McGraw-Hill: New York, 1967 and in the references therein; May, C. A., Ed., Epoxy Resins: Chemistry and Technology, Marcel Dekker Inc.: New York, 1988 and in the references therein; and in U.S. Pat. No. 3,117,099; all which are incorporated herein by reference.

In one preferred embodiment, the epoxide can be a fluid, a semi-solid, or a solid at 25° C.; most preferably a fluid at 25° C. The epoxide preferably has a viscosity, in general, of less than about 50,000 mPa·s, preferably less than about 25,000 mPa·s, and more preferably less than about 15,000 mPa·s at 25° C.

Suitable epoxides useful in the curable liquid stereolithography resin include, for example, liquid epoxy resin such as for example those sold under the trademark D.E.R.™ commercially available from The Dow Chemical Company; and cycloaliphatic epoxides, such as for example Celloxide 2021, 2021A, and 2021P, commercially available from Daicel.

Other suitable epoxides include, for example, Vikolox epoxide products from Atochem; and glycidyl esters, for example hexahydrophthalic anhydride diglycidyl ester.

Still other suitable epoxides include epoxy reactive diluents, for example, C₁₂-C₁₄ alkyl glycidyl ether (also known as Epoxide 8), ortho-cresylglycidyl ether, 1,4-butanediol diglycidyl ether, 1,6-hexanediol diglycidyl ether, trimethylol-propane triglycidyl ether, 2-ethylhexylglycidyl ether, and versatic acid glycidyl ester (also known as Glydexx N10 from Exxon-Mobil); and mixtures thereof.

Yet other suitable epoxides include vegetable oil epoxides, such as for example linseed oil and soybean oil epoxides. Non-limiting examples of such vegetable oils include Flexol LOE and Flexol EPO, commercially available from The Dow Chemical Company.

Other non-limiting examples of epoxides useful in the curable liquid stereolithography resin include limonene dioxide, vinylcyclohexene monoxide and vinylcyclohexene dioxide, styrene oxide. Still other examples include organic compounds that have an epoxide functionality at the terminal end of a polymer chain.

One preferred embodiment of a useful epoxide includes those epoxides that contribute to the desired properties of the curable liquid stereolithography resin, including but not limited to fast UV cure, low viscosity, low cost, and favorable mechanical properties of cured articles prepared from the resin.

### Oxetanes

As a further example, the cationically curable component may comprise one or more oxetanes, which are four-membered cyclic ethers.

Suitable oxetanes may include, for example, 3-ethyl-3hydroxy(methyl)oxetane (also known as trimethylolpropane oxetane, and available as OXT-101 from Toagosei, S-101 from Synasia and available as T1VIPTO from Perstorp). Other suitable oxetanes include the following examples available from Toagosei: 1,4-bis[(3-ethyl-oxetanylmethoxy)methyl]benzene also known as OXT-121; 3-ethyl-3-phenoxymethyloxetane also known as OXT-211; bis{[1-ethyl(3-oxetanyl)]-methyl}ether also known as OXT-221; and 3-ethyl-3-[(2-ethyl-hexyloxy)methyl]oxetane also known as OXT-212; and OXT-610 silyloxetane.

The following are additional, non-limiting examples of oxetane compounds which are suitable for the curable liquid stereolithography resins provided herein: 3-ethyl-3-hydroxymethyloxetane, 3-(meth)allyloxymethyl-3-ethyloxetane, (3-ethyl-3-oxetanylmethoxy)methylbenzene, 4-fluoro-[1(3-ethyl-3-oxetanylmethoxy)methyl]benzene, 4-methoxy-[1-(3-ethyl-3-oxetanylmethoxy)methyl]benzene, [1-(3-ethyl-3-oxetanylmethoxy)ethyl]phenyl ether, isobutoxymethyl(3-ethyl-3-oxetanylmethyl)ether, isobomyloxyethyl(3-ethyl-3-oxetanylmethyl)ether, isobornyl(3-ethyl-3-oxetanylmethyl)ether, 2-ethylhexyl(3-ethyl-3-oxetanylmethyl)ether, ethyldiethylene glycol(3-ethyl-3-oxetanylmethyl)ether, dicyclopentadiene(3-ethyl-3-oxetanylmethyl)ether, dicyclopentenyloxyethyl(3-ethyl-3-oxetanylmethyl)ether, dicyclopentenyl(3-ethyl-3-oxetanylmethyl)ether, tetrahydrofurfuryl(3-ethyl-3-oxetanylmethyl)ether, tetrabromophenyl(3-ethyl-3-oxetanylmethyl)ether, 2-tetrabromophenoxyethyl(3-ethyl-3-oxetanylmethyl)ether, tribromophenyl(3-ethyl-3-oxetanylmethyl)ether, 2-tribromophenoxyethyl(3-ethyl-3-oxetanylmethyl)ether, 2-hydroxyethyl(3-ethyl-3-oxetanyl methyl)ether, 2-hydroxypropyl(3-ethyl-3-oxetanylmethyl)ether, butoxyethyl(3-ethyl-3-oxetanylmethyl)ether, pentachlorophenyl(3-ethyl-3-oxetanylmethyl)ether, pentabromophenyl(3-ethyl-3-oxetanylmethyl)ether, bornyl(3-ethyl-3-oxetanylmethyl)ether, and the like. Other examples of oxetane compounds suitable for use include trimethylene oxide, 3,3-dimethyloxetane, 3,3-dichloromethyloxetane, 3,3-[1,4-phenylene-bis(methyleneoxymethylene)]-bis(3-ethyloxetane), 3-ethyl-3-hydroxymethyl-oxetane, and bis-[(1-ethyl(3-oxetanyl)methyl)]ether. 3,7-bis(3-oxetanyl)-5-oxa-nonane, 3,3′-(1,3-(2-methyleny)propanediylbis(oxymethylene))bis-(3-ethyloxetane), 1,4-bis[(3-ethyl-3-oxetanylmethoxy)methyl]benzene, 1,2-bis[(3-ethyl-3-oxetanylmethoxy)methyl]ethane, 1,3-bis[(3-ethyl-3-oxetanylmethoxy)methyl]propane, ethylene glycol bis(3-ethyl-3-oxetanylmethyl)ether, dicyclopentenyl bis(3-ethyl-3oxetanylmethyl)ether, triethylene glycol bis(3-ethyl-3oxetanylmethyl)ether, tetraethylene glycol bis(3-ethyl-3-oxetanylmethyl)ether, tricyclodecanediyldimethylene(3-ethyl-3-oxetanylmethyl)ether, trimethylolpropane tris(3-ethyl-3-oxetanylmethyl)ether, 1,4-bis(3-ethyl-3-oxetanylmethoxy)butane, 1,6-bis(3-ethyl-3-oxetanylmethoxy)hexane, pentaerythritol tris(3-ethyl-3-oxetanylmethyl)ether, pentaerythritol tetrakis(3-ethyl-3-oxetanylmethyl)ether, polyethylene glycol bis(3-ethyl-3-oxetanylmethyl)ether, dipentaerythritol hexakis(3-ethyl-3-oxetanylmethyl)ether, dipentaerythritol pentakis(3-ethyl-3-oxetanylmethyl)ether, dipentaerythritol tetrakis(3-ethyl-3-oxetanylmethyl)ether, caprolactone-modified dipentaerythritol hexakis(3-ethyl-3-oxetanylmethyl)ether, caprolactone-modified dipentaerythritol pentakis(3-ethyl-3-oxetanylmethyl)ether, ditrimethylolpropane tetrakis(3-ethyl-3-oxetanylmethyl)ether, EO-modified Bisphenol A bis(3-ethyl-3-oxetanylmethyl)ether, PO-modified Bisphenol A bis(3-ethyl-3-oxetanylmethyl)ether, EO-modified hydrogenated Bisphenol A bis(3-ethyl-3-oxetanylmethyl)ether, PO-modified hydrogenated Bisphenol A bis(3-ethyl-3-oxetanylmethyl)ether, EO-modified Bisphenol F (3-ethyl-3-oxetanylmethyl)ether, and the like.

Non-limiting examples of commercially available oxetane compounds include Aron Oxetane OXT-101, OXT-121, OXT-211, OXT-212, OXT-221, OXT-610 and OX-SQ (available from Toagosei Co. Ltd.) and Syna epoxy 101 from Synasia; Uvacure® 1500 (3,4-epoxycyclohexylmethyl-3′,-4-′epoxycyclohexanecarboxylate, available from UCB Chemicals Corp.); Epalloy® 5000 (epoxidized hydrogenated Bisphenol A, available from CVC Specialties Chemicals, Inc.) Heloxy™ 48 (trimethytol propane triglycidyl ether, available from Resolution Performance Products LLC); Heloxy™ 107 (diglycidyl ether of cyclohexanedimethanol, available from Resolution Performance Products LLC); Uvacure® 1501 and 1502 which are proprietary cycloaliphatic epoxides, Uvacure® 1530-1534 which are cycloaliphatic epoxides blended with a proprietary polyol, Uvacure® 1561 and Uvacure® 1562, which are proprietary cycloaliphatic epoxides having a (meth)acrylic unsaturation (all available from UCB Chemicals Corp.); Cyracure® UVR-6100, -6105, -6107, and -6110, which all comprise 3,4-epoxycyclohexylmethyl-3′,4′-epoxycyclohexanecarboxylate; Cyracure® UVR-6128, a bis(3,4-epoxycyclohexyl)adipate; Araldite® CY 179, a 3,4-epoxycyclohexylmethyl-3′,4′-epoxycyclohexanecarboxylate and Araldite® PY 284, a digycidyl hexahydrophthalate polymer (available from Huntsman Advanced Materials Americas Inc.); Celloxide™ 2021, a 3,4-epoxycyclohexyl methyl-3′,4′-epoxycyclohexyl carboxylate, Celloxide™ 2021 P, a 3′-4′-epoxycyclohexanemethyl 3′-4′-epoxycyclohexylcarboxylate, Celloxide™ 2081, a 3′-4′-epoxycyclohexanemethyl 3′-4′-epoxycyclohexylcarboxylate modified caprolactone, Celloxide™ 2083, Celloxide™ 2085, Celloxide™ 2000, Celloxide™ 3000, Epolead GT-300, Epolead GT-302, Epolead GT-400,Epolead 401, Epolead 403 (all available from Daicel Chemical Industries Co., Ltd.) DCA, an alicyclic epoxy (available from Asahi Denka Co. Ltd); and E1, an epoxy hyperbranched polymer obtained by the polycondensation of 2,2-dimethylolpropionic acid functionalized with glycidyl groups (available from Perstorp AB); and combinations thereof.

### Amount of the Cationically Curable Component

The stereolithography resin may comprise the cationically curable component, for example, in an amount of from about 10% by weight to about 80% by weight, from about 20% by weight to about 75% by weight, from about 30% by weight to about 70% by weight, from about 40% by weight to about 70% by weight, or from about 50% by weight to about 65% by weight of the composition.

The cationically curable component may comprise a single cationically curable compound. Alternatively, the cationically curable component may comprise a combination of two or more cationically curable compounds, which may be of similar or different chemical structures. For example, the cationically curable component may comprise a combination of one or more epoxides and one or more oxetanes.

For example, when the cationically curable component comprises at least one epoxide (for example, a liquid epoxy resin) and at least one oxetane, the epoxide may be present in an amount of from about 20% by weight to about 60% by weight, from about 30% by weight to about 50% by weight, or from about 35% by weight to about 48% by weight. Likewise, when the cationically curable component comprises at least one epoxide (for example, a liquid epoxy resin) and at least one oxetane, the oxetane may be present in an amount of from about 5% by weight to about 25% by weight, from about 5% by weight to about 20% by weight, from about 10% by weight to about 20% by weight, or from about 12% by weight to about 20% by weight.

### Stabilizers

The stereolithography resin may optionally comprise a stabilizer component comprising one or more stabilizers. Without being bound to a particular theory, stabilizers may be added to the stereolithography resin to prevent build-up of viscosity during usage.

Non-limiting examples of stabilizers useful in the compositions provided herein include 2,6-di-tert-butyl-4-methylphenol (BHT), styrenated phenol, 2,2′-thiodiethylene bis[3-(3,5-di-tert-butyl-4-hydroxyphenyl)propionate], 2,6-di-t-butylphenol, 2,6-di-t-butyl-4-ethylphenol, 2,6-dicyclopentylphenol, 2,6-dicyclooctyl-4-methylphenol, 2-t-butyl-4-methyl-6-cyclohexylphenol, 2,6-dibenzyl-4-n-butylphenol, 2,6-di(1-naphthyl)phenol and mixtures thereof.

The curable liquid stereolithography resin may comprise the stabilizer component, for example, in an amount of from about 0.005% by weight to about 3% by weight, from about 0.01% by weight to about 2% by weight, or from about 0.1% by weight to about 1% by weight of the composition.

### Other Optional Components

Additives known useful for the preparation, storage, and curing of resin compositions may be used as optional additional components in the curable liquid stereolithography resins provided herein.

The curable liquid stereolithography resin may optionally contain one or more other additives which are useful for their intended uses. Non-limiting examples of optional additives which may be useful in the curable liquid stereolithography resin include: surfactants such as silicones; flow modifiers; dyes; matting agents; degassing agents; flame retardants (e.g., inorganic flame retardants, halogenated flame retardants, and non-halogenated flame retardants such as phosphorus-containing materials); toughening agents such as elastomers and liquid block copolymers; curing inhibitors; wetting agents; colorants; thermoplastics; processing aids; fluorescent compounds; inert fillers such as clay, talc, silica, and calcium carbonate; fibrous reinforcements; fibers such as fiberglass and carbon fiber; antioxidants; impact modifiers including thermoplastic particles; solvents such as ethers and alcohols; and mixtures thereof. The above list is intended to be exemplary and not limiting. he preferred additives for the formulation may be optimized by the skilled artisan.

Non-limiting examples of surfactants which may optionally be used in the curable liquid stereolithography resin include polysiloxane type surfactants, fluorinated surfactants, acrylic copolymers, and mixtures thereof. Non-limiting examples of preferred toughening agents useful in the compositions provided herein include carboxyl-terminated butadiene nitrile liquid rubber (CTBN), liquid block copolymers, liquid polyols, core-shell rubber particles, and mixtures thereof.

The concentration of the additional additives is generally from about 0% by weight to about 20% by weight; preferably, from about 0.01% by weight to about 15% by weight; more preferably, between about 0.1% by weight to about 10% by weight; and most preferably, between about 0.1% by weight to about 5% by weight of the composition.

### Preparation of the Curable Liquid Stereolithography Composition

The preparation of the curable liquid stereolithography resin may be achieved, for example, by admixing (a) a divinylarene dioxide; (b) one or more cationically curable components; (c) a free radically curable (meth)acrylate components; (d) a cationic photoinitiator; (e) a free radical photoinitiator; and, optionally, one or more additives.

Generally, the components may be added to the mixing equipment in any order or simultaneously. In one embodiment, the divinylarene dioxide component is added to the mixing equipment first, followed by the addition of the further components of the stereolithography resin.

The components of the curable divinylarene dioxide resin composition are typically mixed and dispersed at a temperature enabling the preparation of an effective curable liquid stereolithography resin having a low viscosity for the desired application. The temperature during the mixing of all components may be generally from about 0° C. to about 100° C., and preferably from about 20° C. to about 50° C.

### Methods of Preparing Cured Articles

The curable liquid stereolithography resins provided herein are useful in standard stereolithography equipment and processes known in the art.

For example, provided herein is a method of creating a cured article using stereolithography, the method comprising the steps of: (a) selectively applying a curable liquid stereolithography resin to a surface; (b) selectively applying electromagnetic radiation to the curable liquid stereolithography resin to form a first cured resin layer; (c) applying a second layer of the curable liquid stereolithography resin on the first cured resin layer; and (d) selectively applying electromagnetic radiation to the second layer of the curable liquid stereolithography resin to form a second cured resin layer, wherein the curable liquid stereolithography resin is as described herein.

In the stereolithography process, the step of applying electromagnetic radiation may comprise applying ultraviolet light, microwave radiation, visible light, LED, or laser beams. For example, the step of applying electromagnetic radiation may comprise applying visible light.

The stereolithography process may further comprise a post-curing step wherein the object is post-cured using thermal or electromagnetic radiation.

### Cured Objects

Also provided herein is a cured object produced using a stereolithography resin as described herein. For example, the cured object may be produced using a stereolithography process as described above.

The liquid stereolithography resin can be cured to form a rigid, three-dimensional object. By “rigid,” it is meant that the cured resin has a measureable Shore D hardness of greater than 50. For example, the Shore D hardness of the cured resin may be at least about 75, at least about 80, or at least about 85.

Advantageously, the curable liquid stereolithography resins provided herein can be used to provide a cured resin that exhibits desirable mechanical properties, such as a high degree of structural strength. For example, the cured resin may have a flexural strength of at least about 55 MPa, at least about 60 MPa, at least about 65 MPa, at least about 70 MPa, or at least about 75 MPa.

The cured resin may have a flexural modulus of, for example, at least about 1000 MPa, at least about 1500 MPa, at least about 2000 MPa, at least about 2300 MPa, at least about 2400 MPa, at least about 2500 MPa, at least about 2600 MPa, at least about 2700 MPa, at least about 2800 MPa, or at least about 2900 MPa.

The cured resin may have a tensile strength of at least about 30 MPa, at least about 40 MPa, or at least about 50 MPa. For example, the cured resin may have a tensile strength of from about 40 MPa to about 80 MPa, from about 40 MPa to about 70 MPa, or from about 40 MPa to about 60 MPa.

Without being bound to a particular theory, it is believed that the divinylarene dioxide component of the curable liquid stereolithography resin provides the beneficial mechanical properties associated with conventional epoxide resins, but without the corresponding increase in viscosity or decrease in cure rate. The claimed compositions may therefore comprise a relatively high proportion of epoxide-containing compounds (e.g., a divinylarene dioxide and, optionally, at least one other epoxide compound) without the drawbacks associated with conventional epoxy-based stereolithography resins. For example, in some embodiments, the divinylarene dioxide and the at least one other epoxide compound constitute at least about 40% by weight, at least about 45% by weight, or at least about 50% by weight of the curable liquid stereolithography resin as a whole.

Cured articles produced as described herein may be used, for example, in investment casting processes.

Other objects and features will be in part apparent and in part pointed out hereinafter.

### EXAMPLES

The following non-limiting examples are provided to further illustrate the present disclosure.

### Experimental Materials

Unless otherwise indicated, the materials listed in Table 1 were used to prepare the Inventive Examples and Comparative Examples described herein.

TABLE 1
Materials

| Product | Description | Vendor |
|---|---|---|
| XU 19127.00 Experimental | Divinylbenzene dioxide | Olin |
| Epoxy Resin | | |
| Epalloy 5000 Epoxy Resin | Diglycidyl ether of | CVC |
| | Hydrogenated Bisphenol- A | |
| Syna Epoxy 101 (S-101) | 3-Ethyl-3-hydroxymethyl- | Synasia |
| | oxetane | |
| EBECRYL 130 radiation | Tricyclodecanediol diacrylate | Allnex |
| curing resins | | |
| UVI6992 | Triarylsulfonium | Aceto Corp |
| | hexafluorophosphate salts | |
| Omnirad 184 | 1-Hydroxylcyclohexyl phenyl | IGM Resins |
| | ketone | |

### Preparation of Inventive Examples 1 and 2 and Comparative Example A

The following procedure was used to prepare exemplary curable liquid stereolithography resins as provided herein (referred to below as Inventive Example 1 and Inventive Example 2), as well as a comparative resin comprising no divinyarene dioxide Comparative Example A). To prepare each resin, the components listed in Table 1 below were weighed and mixed with FlackTek SpeedMixer at 2000 rpm at room temperature.

TABLE 2
Examples of photo-curable epoxy resin composition

| | | Comparative | Inventive | Inventive |
|---|---|---|---|---|
| Component | Materials | Example A | Example 1 | Example 2 |
| (a) Divinylarene | Divinylbenzene dioxide | | 10 | 15 |
| dioxide | (XU 19127) | | | |
| (b) Cationically | Diglycidyl ether of | 47 | 42 | 39.5 |
| curable | Hydrogenated Bisphenol- A | | | |
| component | (Epalloy 5000 Epoxy Resin) | | | |
| (b) Cationically | 3-Ethyl-3-hydroxymethyl- | 18 | 16 | 15 |
| curable | oxetane (S-101) | | | |
| component | | | | |
| (c) Free radically | Tricyclodecanediol | 28 | 25 | 23.5 |
| curable | diacrylate (EBECRYL 130) | | | |
| (meth)acrylate | | | | |
| component | | | | |
| (d) Cationic | Triarylsulfonium | 5 | 5 | 5 |
| photoinitiator | hexafluorophosphate salts | | | |
| | (UVI6992) | | | |
| (e) Free radical | 1-Hydroxylcyclohexyl | 2 | 2 | 2 |
| photoinitiator | phenyl ketone (Omnirad | | | |
| | 184) | | | |

Table 1 shows the composition of each curable liquid stereolithography resin tested in the following examples. Inventive Example 1 includes 10% by weight of divinylbenzene dioxide (component (a) of the curable liquid stereolithography resins provided herein), and Inventive Example 2 includes 20% by weight of divinylbenzene dioxide. In contrast to Inventive Examples 1 and 2, Comparative Example A does not include a divinylarene dioxide.

### Preparation of Clear Casting Plaques with UV Equipment

Glass molds were made from “U”-shaped, 0.3 cm thick spacers compressed between two 20 cm×20 cm glass plates. Once assembled, the mold was clamped together and stood on end so the open end of the “U”-shaped spacer faced upward. The plaques were held stable on the bench during and after assembly.

The photo-curable resin was filled from the top into the glass mold. The glass mold filled with photo-curable resin was then passed through a Fusion system UV curing unit several times until the resin composition was fully cured (typically about 5 minutes under UV light).

The Fusion system UV curing unit used in this example included a Model DRS-120 adjustable conveyor system equipped with conveyor speed control dial, Model 6000 ultraviolet (UV) irradiator module, Model P600 power supply for the UV irradiator, and a Model H 600 W/in. electrodeless quartz UV lamp that emitted radiation in the region of from 200 to 400 nm.

### Thermal Rheology Analysis

Thermal rheology analysis of each UV-cured plaque was performed using a Discovery Hybrid Rheometers (DHR) from TA Instruments with 40 mm, 2.0 plate (Serial number 106204).

### Dynamic Mechanical Thermal Analysis

The glass transition temperature, Tg, was determined by Dynamic Mechanical Thermal Analysis (DMT A) in accordance with ASTM D4065-12 using an ARES rheometer from TA Instruments. Rectangular samples (approximately 6.35 cm×1.27 cm×0.32 cm) were placed in solid state fixtures and subjected to an oscillating torsional load. The samples were thermally ramped from about 20° C. to about 200° C. at a rate of 3° C./minute and 1 Hz frequency.

### Mechanical Properties

The three-point bending flexural tests were performed using ASTM D790 method.

### Analysis of Inventive and Comparative Examples

The data collected as described above are presented in Table 2, below.

TABLE 3
Analysis of Inventive and Comparative Examples

| | Comparative | Inventive | Inventive |
|---|---|---|---|
| Properties | Example A | Example 1 | Example 2 |
| Viscosity at 25° C. (mPa · s) | 450 | 270 | 210 |
| Density of liquid (g/ml) | 1.12 | 1.12 | 1.12 |
| Tg (° C., Tanδ) | 62.5 | 90 | 96 |
| Shore D Hardness | 85 | 85 | 85 |
| Flexural Strength (MPa) | 53 | 76 | 81 |
| Flexural Modulus (MPa) | 1843 | 2919 | 2944 |
| Flexural strain (%) | 4.2 | 3.2 | 3.0 |

As shown in the table above, the viscosity of Comparative Example A at 25° C. is about 450 mPa·s, and the Tg of the UV cured plaque prepared from this resin is about 62.5° C.

The addition of divinylbenzene dioxide in Inventive Examples 1 and 2 advantageously lowered the viscosity of the liquid curable resin (to 270 mPa·s and 210 mPa·s, respectively, at 25° C.). The addition of divinylbenzene dioxide in Inventive Examples 1 and 2 also increased the Tg of the UV cured plaque prepared from these resins (to 90° C. and 96° C., respectively). The Flexural Strength and Flexural Modulus of Inventive Examples 1 and 2 were also significantly increased relative to Comparative Example A. The hardness of the UV cured plaques were similar across all three tested resins.

### Additional Mechanical Properties

Based on the typical relationship between flexural strength and tensile strength observed for liquid epoxy resin formulations, it is expected that the tensile strength of Inventive Examples 1 and 2 is in the range of from about 40 MPa to about 60 MPa.

When introducing elements of the present disclosure or the preferred embodiment(s) thereof, the articles “a”, “an”, “the”, and “said” are intended to mean that there are one or more of the elements. The terms “comprising”, “including”, and “having” are intended to be inclusive and mean that there may be additional elements other than the listed elements.

In view of the above, it will be seen that the several objects of the disclosure are achieved and other advantageous results attained.

As various changes could be made in the above products and methods without departing from the scope of the disclosure, it is intended that all matter contained in the above description shall be interpreted as illustrative and not in a limiting sense.

1. A curable liquid stereolithography resin comprising:
(a) a divinylarene dioxide;
(b) a free radically curable component;
(c) a cationic photoinitiator; and
(d) a free radical photoinitiator;
wherein said resin is photocurable to form a cured resin having a measureable Shore D hardness of least about 75.

2. The curable liquid stereolithography resin of claim 1 comprising a divinylarene dioxide and at least one other epoxide compound,
wherein the divinylarene dioxide and the at least one other epoxide compound constitute at least about 40% by weight of the curable liquid stereolithography resin as a whole.

3. The curable liquid stereolithography resin of claim 1 having a viscosity at 25° C. of less than 400 mPa·s.

4-7. (canceled)

8. The curable liquid stereolithography resin of claim 1 wherein said resin is photocurable to form a cured resin having a flexural strength of at least about 55 MPa and a tensile strength of at least about 30 MPa.

9-11. (canceled)

12. The curable liquid stereolithography resin of claim 1 further comprising a cationically curable component other than divinylarene dioxide.

13-15. (canceled)

16. The curable liquid stereolithography resin of claim 12 wherein the cationically curable component comprises at least one oxetane.

17. The curable liquid stereolithography resin of claim 16 wherein the cationically curable component comprises at least one oxetane selected from the group consisting of 3-ethyl-3-hydroxymethyloxetane, 3-(meth)allyloxymethyl-3-ethyloxetane, (3-ethyl-3-oxetanylmethoxy)methylbenzene, 4-fluoro-[1(3-ethyl-3-oxetanylmethoxy)methyl]benzene, 4-methoxy-[1-(3-ethyl-3-oxetanylmethoxy)methyl]benzene, [1-(3-ethyl-3-oxetanylmethoxy)ethyl]phenyl ether, isobutoxymethyl(3-ethyl-3-oxetanylmethyl)ether, isobomyloxyethyl(3-ethyl-3-oxetanylmethyl)ether, isobornyl(3-ethyl-3-oxetanylmethyl)ether, 2-ethylhexyl(3-ethyl-3-oxetanylmethyl)ether, ethyldiethylene glycol(3-ethyl-3-oxetanylmethyl)ether, dicyclopentadiene(3-ethyl-3-oxetanylmethyl)ether, dicyclopentenyloxyethyl(3-ethyl-3-oxetanylmethyl)ether, dicyclopentenyl(3-ethyl-3-oxetanylmethyl)ether, tetrahydrofurfuryl(3-ethyl-3-oxetanylmethyl)ether, tetrabromophenyl(3-ethyl-3-oxetanylmethyl)ether, 2-tetrabromophenoxyethyl(3-ethyl-3-oxetanylmethyl)ether, tribromophenyl(3-ethyl-3-oxetanylmethyl)ether, 2-tribromophenoxyethyl(3-ethyl-3-oxetanylmethyl)ether, 2-hydroxyethyl(3-ethyl-3-oxetanyl methyl)ether, 2-hydroxypropyl(3- ethyl-3-oxetanylmethyl)ether, butoxyethyl(3-ethyl-3-oxetanylmethyl)ether, pentachlorophenyl(3-ethyl-3-oxetanylmethyl)ether, pentabromophenyl(3-ethyl-3-oxetanylmethyl)ether, bornyl(3-ethyl-3-oxetanylmethyl)ether, and combinations thereof.

18. The curable liquid stereolithography resin of claim 17 wherein the cationically curable component comprises 3-ethyl-3-hydroxymethyl-oxetane.

19. The curable liquid stereolithography resin of claim 12 wherein the cationically curable component comprises:
at least one epoxide; and
at least one oxetane.

20. The curable liquid stereolithography resin of claim 19 comprising the at least one epoxide in an amount of from about 20% by weight to about 60% by weight of the curable liquid stereolithography resin as a whole.

21. The curable liquid stereolithography resin of claim 19 comprising the at least one oxetane in an amount of from about 5% by weight to about 25% by weight of the curable liquid stereolithography resin as a whole.

22. The curable liquid stereolithography resin of claim 1 wherein the free radically curable component comprises at least one (meth)acrylate compound.

23-25. (canceled)

26. The curable liquid stereolithography resin of claim 1 wherein the cationic photoinitiator comprises a triarylsulfonium hexafluorophosphate salt, high molecular weight sulfonium tetrakis[pentafluorophenyl] boratediarylferrocinium salt, (4-methylphenyl)(4′-isobutylphenyl)iodonium hexafluorophospate, or a combination thereof.

27. The curable liquid stereolithography resin of claim 1 comprising the cationic photoinitiator in an amount of from about 0.05% by weight to about 10% by weight of the curable liquid stereolithography resin as a whole.

28. The curable liquid stereolithography resin of claim 1 wherein the free radical photoinitiator comprises 1-hydroxylcyclohexyl phenyl ketone.

29. The curable liquid stereolithography resin of claim 1 comprising the free radical photoinitiator in an amount of from about 0.1% by weight to about 10% by weight of the curable liquid stereolithography resin as a whole.

30-34. (canceled)

35. A cured resin prepared by curing the curable liquid stereolithography resin of claim 1.

36. A process of creating a rigid, three-dimensional object using stereolithography, the process comprising the steps of:
(a) selectively applying a curable liquid stereolithography resin to a surface;
(b) selectively applying electromagnetic radiation to the curable liquid stereolithography resin to form a first cured resin layer;
(c) applying a second layer of the curable liquid stereolithography resin on the first cured resin layer; and
(d) selectively applying electromagnetic radiation to the second layer of the curable liquid stereolithography resin to form a second cured resin layer,
wherein the curable liquid stereolithography resin is a stereolithography resin as set forth in claim 1.

37-38. (canceled)

39. A rigid, three-dimensional object produced using the process of claim 36.

40. An investment casting process utilizing the rigid, three-dimensional object of claim 39.
